(19) United States
(12) Patent Application Publication
(10) Pub. No.: US 2003/0235483 A1
(43) Pub. Date: Dec. 25, 2003

(54) Screw with a pointed end

(76) Inventor: Ho-Tien Chen, Tainan City (TW)

Correspondence Address: J.C Patents, Inc, Suite 250, 4 Venture, Irvine, CA, 92618, US

(21) Appl. No.: 10/179,130

(22) Filed: Jun. 25, 2002

(51) Int. Cl. F16B 25/10

(52) U.S. Cl. 411/387.7

(57) ABSTRACT

A screw with a pointed end includes a head, a shank, and a conical end portion formed in a lower portion of the shank. The conical end portion has a drill thread and an incomplete securing thread. The drill thread extends upward from a pointed end of the conical end portion to an upper end of the conical end portion. The incomplete securing thread has its lower end connected to the drill thread so that cut waste may not be hampered by the incomplete securing thread when the screw begins to move into a wooden object and cut and drill a hole therein. Then cut waste may smoothly move out of the wooden object so as not to let it split or tear, with operating twisting force diminished and securing force enhanced.

### BACKGROUND OF THE INVENTION

This invention relates to a screw with a pointed end, particularly to one exhausting cut waste bits of wood smoothly, and enhanced effect in securing objects.

At present screws have three problems, namely, swaying, operating twisting force, and securing force. When a tool rotates a screw in a wooden object, the screw should sway with comparatively little degree so as to drive easily the screw accurately straight in the wooden object. The operating twisting force is caused either by squeezing against an object or friction between the screw and the object during rotating the screw. The securing force is a resistant force against separating of the screw from the object caused by exterior force after the screw is driven in the object.

As shown in FIG. 1, a first conventional screw A has two portions of threads, complete threads A4 of the shank A2 and incomplete securing threads A3 of a conical portion A1. When the screw A is rotated by a hand tool to move into an object, the threads moves helically in the object by squeezing action. If the screw is wanted to move in an object, it depends on the incomplete threads A3 of the conical portion, therefore, the threads have to cut a helical groove (track) in the object, and to form a conical shaft hole in the object. This is the main reason that the twisting force happens in driving the screw in the object. As for the complete threads A4, they only move along the track made by the incomplete threads A3, producing only friction force. The friction force accounts for a small portion of the total operating twisting force. Therefore, if the screw is used for a comparatively hard object, it needs a very large operating twisting force. For a long screw this condition is very serious, possible to cause the screw break off to give a harm to a worker.

Next, as shown in FIG. 2, a second conventional improved screw has a hole drilling thread B1 provided with a larger angle than those of securing threads B2, possible to have drilling effect of a drill by firstly drilling a small hole and then cut a helical groove in an object, lowering operating twisting force needed. But such a screw may easily sway to leave the original secured position, owing to the drilling thread B1 having only drilling function but no function of securing the screw with the object.

Further, a third conventional screw disclosed in U.S. Pat. No. 4,834,602 has threads C divided into two stages C1 and C2 separated by drilling threads C3. The drilling threads C3 are for drilling and carrying out cutting wood bits, and the incomplete securing threads C1 of a short stage squeezes firstly an object so as to correct the screw into a straight condition so the screw may not sway easily. Then the drilling threads C3 damages the helical groove already formed in the object, forming a diameter of a hole. After that the complete securing threads C2 evolves and moves in the object helically. Though this third conventional screw resolves the disadvantage of swaying and partial twisting force (friction), it has to depend on the incomplete securing threads C1 in squeezing the object, not thoroughly resolve the problem of the operating twisting force. Besides, the diameter of the hole opened by the drilling threads C3 is a little smaller than the diameter D of the securing threads C2, with securing force between the screw and the object being not enough so the screw may easily separate from the object by exterior force.

Furthermore, a fourth conventional screw shown in FIG. 4 is disclosed in a U.S. Pat. No. 4,241,638, having a first screw threads D1, a second screw threads D2 and a third screw threads D3. The third screw threads D3 has a function of cutting a thin iron plate, and the first screw threads D1 and the second screw threads D2 have function of securing the screw with an object. The drawback of this screw is the same guiding function that all the three screw threads, D1, D2, and D3 have, only producing the same function that the screws shown in FIGS. 1 and 2, that is, the function of squeezing a wooden object, impossible to cut the wooden object. So the fourth conventional screw shown in FIG. 4 cannot be moved without large operating twisting force or without causing split or tear of a wooden object.

Lastly, another U.S. Pat. No. 135,760 obtained by the same applicant of this invention, also has almost the same disadvantages mentioned above.

### SUMMARY OF THE INVENTION

One purpose of the invention is to offer a screw with a pointed end, which needs a small operating twisting force, and has comparatively small swaying and high securing force.

Another purpose of the invention is to offer a screw with a pointed end, which can perform cutting, exhausting cut waste bits of wood, and moving in an object smoothly, and securing tightly with an object.

The feature of the invention is two kinds of threads formed 10 in a conical end portion for first cutting and drilling, and then rotating by cutting a helical groove in an object, lowering largely twisting force needed in squeezing action. Further, when a first complete securing threads moves in an object, the object is already drilled with a hole by a drill thread. So the screw may be rotated to move in the object smoothly with only a little twisting force. Thus operating twisting force for a screw in driving in an object is largely lowered, and the hole drilled out by the drill thread may not affect the securing force of the screw with the object.

Another feature of the invention is that the pointed end has a function of cutting an object so as to destroy wooden fiber smoothly so that the wooden object may not split or tear off, while a conventional screw has its pointed end squeezes wooden fiber of an object in driving the screw in the object so that the wooden object may split along the grain of the wooden fiber.

### BRIEF DESCRIPTION OF DRAWINGS

This invention will be better understood by referring to the accompanying drawings, wherein:

FIG. 1 is a front view of a first conventional screw;

FIG. 2 is a front view of a second conventional screw;

FIG. 3 is a front view of a third conventional screw;

FIG. 4 is a partial front view of a fourth conventional screw;

FIG. 5 is a front view of a first embodiment of a screw with a pointed end in the present invention;

FIG. 6 is a partial magnified front view of the first embodiment of a pointed end in the present invention;

FIG. 7 is a front view of a second embodiment of a screw with a pointed end in the present invention;

FIG. 8 is a partial magnified view of the second embodiment of a screw with a pointed end in the present invention; and,

FIG. 9 is a front and partial cross-sectional view of the second embodiment of a screw with a pointed end in the present invention.

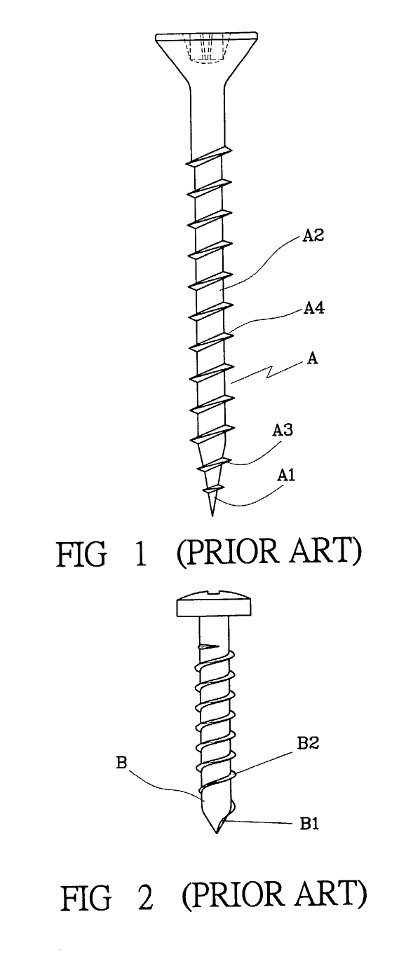

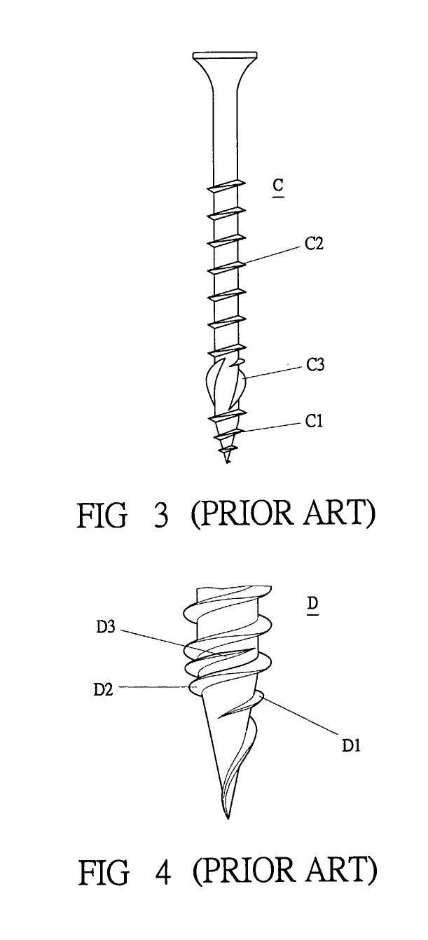

### DETAILED DESCRIPTION OF THE PREFERRED EMBODIMENT

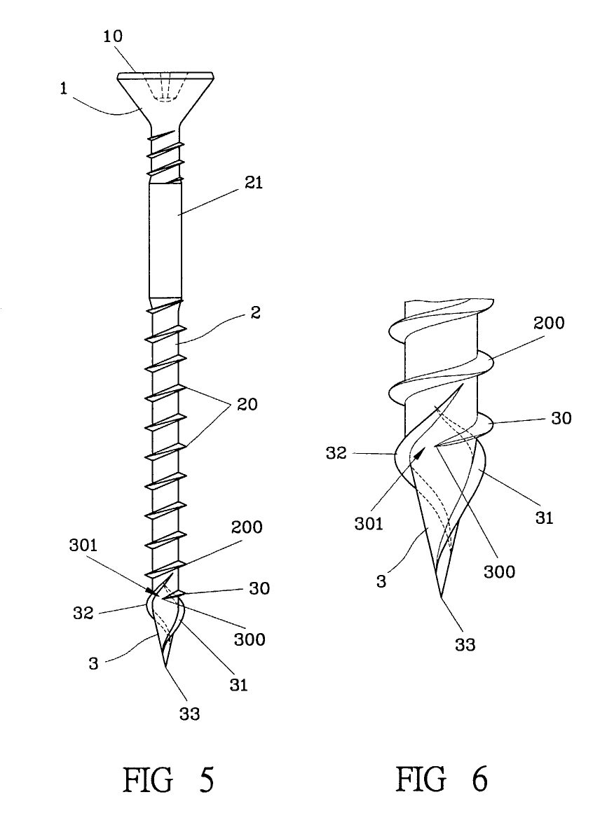

A first preferred embodiment of a screw with a pointed end in the present invention, as shown in FIGS. 5 and 6, includes a head 1, a shank 2 and a conical end portion 3.

The head 1 is of any shape, having a slot in a center for a hand tool to fit therein to rotate the screw.

The shank 2 has complete securing threads 20, and a non-threaded portion 21 provided

between the complete securing threads 20 and the head 1.

The conical end portion 3 is formed in a lower portion of the shank 2, having an incomplete securing thread 30 extending downward below the complete securing threads 20, functioning to drill and squeeze an object, and its lower end 300 does not connect to two drill threads 31 and 32. The drill threads 31 and 32 have a comparatively long length, having function of drilling and cutting.

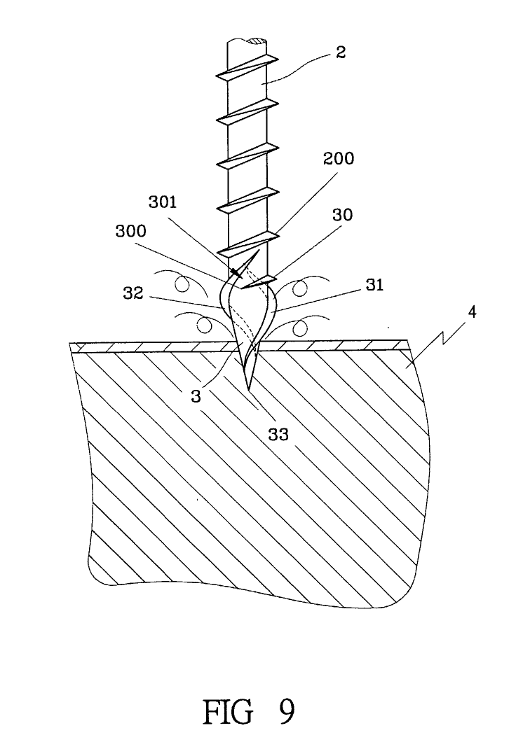

Further, as shown in FIG. 6, the drill threads 31 and 32 extends from a lower tip 33 of the conical end portion 3 or from near the lower tip 33 to a point slightly above an upper end of the conical end portion 3. Then a waste passageway 301 is formed between the incomplete securing thread and the two drill threads 31 and 32. Then the incomplete secure thread 30 does not form a hampering force to cut waste bits of wood produced as the securing threads 30 is not connected to the drill threads 31 or 32 so that cutting action may be carried on smoothly as shown in FIG. 9.

When the conical end portion 3 of the screw completely moves in an object, it already drills a small hole in the object 4. The diameter of the hole is as large as the largest diameter D of the drill thread 31. So when a first securing thread 200 moves in the object 4, a small force is enough for squeezing to cut helical groove (track) in the object 4, and then the securing threads 30 just moves along the cut track, only receiving a twisting force so that the whole operating twisting force is not affected so much. The securing force of the screw does not alter so largely by the cutting action mentioned above, after the screw moves substantially in the object 4. When the screw begins to move in the object 4 and performs cutting, rotating and moving at the same time into the object, some portion of the securing thread 30 firstly inserts in the object 4, so that the screw may not sway too largely owing to the function of maintaining the screw in the straight position

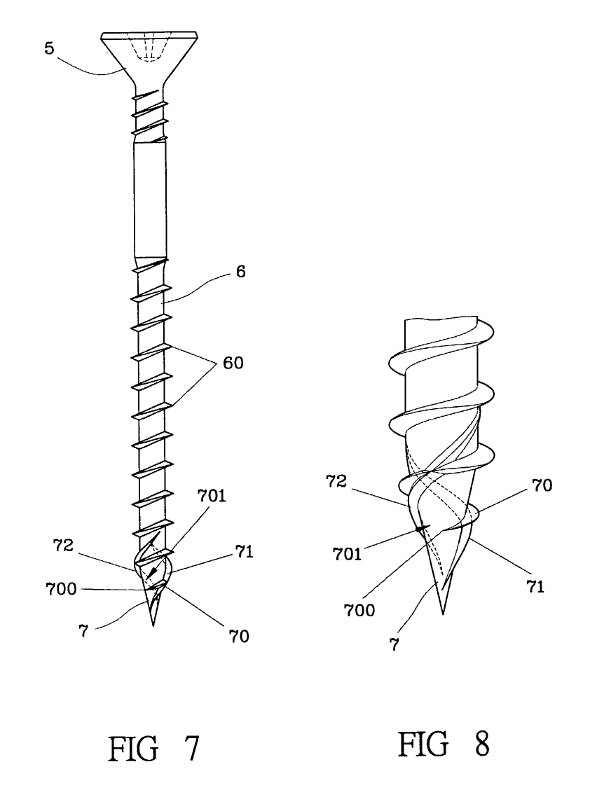

Next, a second preferred embodiment of a screw with a pointed end is shown in FIGS. 7 and 8, having a head 5, a shank 6 under the head 5, complete securing threads 60 formed on the shank 6, and a conical end portion 7 formed in a lower portion. The conical end portion 7 has an incomplete securing thread 70 and two drill threads 71, 72, with the end 700 of the incomplete securing thread 70 not connected to the two drill threads 71 and 72 so as to form a waste passageway 701 between the incomplete securing thread and the two drill threads 71 and 72. Therefore, the second embodiment has the same function as the first embodiment.

The invention has the following advantages, as can be understood from the aforesaid description.

1. Cut waste wooden bits may not be obstructed by the incomplete securing thread, exhausted out smoothly, and wooden objects may not easily split or tear apart by the screw owing to diminished operating twisting force and enhanced securing force.

2. In rotating for securing the screw in an object, the pointed end has a function of cutting and lowering resistance in rotating for securing in the object, not having the disadvantage that a conventional screw has to be squeezed largely to cause splitting of a wooden object.

3. It lessens operating twisting force so as to avoid splitting of a wooden object, and it may not easily break off, with securing force between the screw and the object not diminished.

While the preferred embodiments of the invention have been described above, it will be recognized and understood that various modifications may be made therein and the appended claims are intended to cover all such modifications that may fall within the spirit and scope of the invention.

What is claimed is:

1. A screw with a pointed end comprising a head, a shank, and a conical end portion:
Said head having a slot for a hand tool to fit therein and rotate said screw:
Said shank having complete securing threads on a substantial portion of said shank:
Said conical end portion provided with a incomplete secure thread and a plurality of drill threads, said incomplete secure thread extending downward from under said complete securing threads and having a function of securing with an object, said incomplete securing thread having its lower end not connected to said drill threads and forming a waste wood bits passageway between itself and said drill threads, said drill threads having a comparatively long length and having a function of drilling, said drill threads extending upward from or from near the pointed end to a point a little above an upper end of said conical end portion, said drill threads in advance cutting and drilling in an object for forming a drilling hole, said incomplete securing thread located just between said drill threads so that incomplete securing thread may not obstruct cut waste wooden bits and said drill threads may cut smoothly, said incomplete securing thread having a function of prime securing with the object and maintaining said screw in a straight position, said screw not causing an wooden object to split or tear.

2. The screw with a pointed end as claimed in claim 1, wherein said incomplete securing thread is positioned between two drill threads and connected to said drill threads to form a waste passageway for exhausting cut waste smoothly.
